(19) United States
(12) Patent Application Publication
(10) Pub. No.: US 2023/0116965 A1
(43) Pub. Date: Apr. 20, 2023

(54) FILTER ELEMENT AND FILTER ASSEMBLY, COMPRISING AN ENCODING ELEMENT

(71) Applicant: Carl Freudenberg KG, Weinheim (DE)

(72) Inventors: Maik SIEH, Sandhausen (DE); Guengoer BASTAN, Dreieich (DE); Sascha SCHUMACHER, Wald-Michelbach (DE)

(21) Appl. No.: 18/045,837

(22) Filed: Oct. 12, 2022

(30) Foreign Application Priority Data
Oct. 14, 2021 (EP) 21202643.9

(51) Int. Cl. B01D 46/00; B60H 3/06

(52) U.S. Cl. CPC B01D 46/009; B60H 3/0658; B60H 2003/0683

(57) ABSTRACT

A filter element includes: a filter frame; a bellows of a filter medium accommodated in the filter frame; and a seal externally circumferential on the filter frame. At least one filter-side mechanical encoding element in integrated in the seal. The at least one filter-side encoding element is a recess in the seal, the recess being a groove, a notch, or a trough. The seal has a reduced height in a region of the filter-side encoding element. The seal is a radial seal.

### CROSS-REFERENCE TO PRIOR APPLICATION

Priority is claimed to European Patent Application No. EP 21 202 643.9, filed on Oct. 14, 2021, the entire disclosure of which is hereby incorporated by reference herein.

### FIELD

The present invention relates to a filter element comprising a filter frame, a bellows of a filter medium accommodated in the filter frame, and a seal circumferentially extending around the filter frame. The invention also relates to a filter assembly comprising such a filter element and comprising a filter housing to receive the filter element.

### BACKGROUND

From DE 10 2005 048 841 A1, a filter element is known, which is installed in a housing of a ventilation system of an automotive vehicle. Specifically, in this filter assembly, guiding pins of the housing correspond with guiding channels in the filter element. This is to realize mechanical encoding, which ensures that only a filter element suitable for this housing is inserted into the housing. A drawback is that the filter area is disadvantageously affected by the guiding pins and the filtering performance may be reduced.

DE 10 2009 059 782 B4 shows a filter element for insertion into a housing of a ventilation or air conditioning system, comprising a bellows and at least one encoding side, which can be made to face toward the sidewall of the housing, wherein a profile is associated with the encoding side. The filter element can be inserted into the housing with the narrow side having the profile facing forwards, thus also referred to as a “front loader”. For a so-called “top loader”, in which the filter element is inserted in the flow-through direction, the encoding described here does not work.

### SUMMARY

In an embodiment, the present invention provides a filter element, comprising: a filter frame; a bellows of a filter medium accommodated in the filter frame; and a seal externally circumferential on the filter frame, wherein at least one filter-side mechanical encoding element in integrated in the seal, wherein the at least one filter-side encoding element is configured to be a recess in the seal, the recess comprising a groove, a notch, or a trough, wherein the seal has a reduced height in a region of the filter-side encoding element, and wherein the seal comprises a radial seal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a filter element in a perspective view;

FIG. 2 schematically shows a filter housing for the filter element shown in FIG. 1 in a perspective view; and

FIG. 3 schematically shows a filter assembly comprising the filter element as shown in FIG. 1 and the filter housing as shown in FIG. 2 in a perspective view.

### DETAILED DESCRIPTION

In an embodiment, the present invention provides a mechanical encoding for a filter element which ensures unequivocal association of a filter element with a filter housing while not disadvantageously affecting the effective filter area.

According to the invention, it has been found advantageous to integrate encoding elements in the seal of the filter element, or in the filter housing.

The invention relates to a filter element for air filtration for a vehicle cabin, comprising a filter frame, a bellows accommodated in the filter frame, comprising a filter medium, e. g., of a non-woven material, and a seal circumferentially extending around the filter frame for sealing against a filter housing, in which the filter element can be accommodated. In a possible embodiment, the filter frame can be formed by so-called L sections.

According to the invention, at least one filter-side mechanical encoding element is integrated in the seal. The mechanical encoding element has a specific geometry and has a spatial and physical design. The mechanical encoding is thus not a chemical, magnetic or electronic encoding. The filter-side encoding element can interact with a housing-side encoding element as a counter-element and, together with the latter, form an encoding device. If a plurality of filter-side encoding elements are provided, the same number of housing-side encoding elements can be provided. The functioning of the encoding element and the encoding device is an encoding action in the sense of an anticounterfeit device. Only filter elements with the original encoding element can be inserted into the filter housing. Furthermore, the encoding element can also serve as a positioning assisting device and ensure correct insertion of the filter element into the filter housing, i. e., so that the filter element is brought into the proper position inside the filter housing during installation.

The arrangement of the filter-side encoding element integrated in the seal, according to the invention, ensures in an advantageous manner that the effective filter area of the bellows is not disadvantageously affected or reduced.

According to the present invention, the filter-side encoding element is formed as a recess in the seal, in particular as a groove, notch or trough. Such a recess can be easily realized in process engineering, and a product pirate will find it very difficult to produce it retroactively on the seal without damaging the seal and thus risk leakage.

According to the present invention, the seal, in the region of the filter-side encoding element, has a reduced height as compared with the height of the seal in regions in which there is no encoding element. The reduced height can be, in particular, 20-80% of the regular height. In this context, the height of the seal is the thickness of the seal in the insertion direction.

The seal of the filter element is formed as a radial seal for radial sealing of the filter element against a receiving filter housing. A radial seal can result in good and sealed seating of the filter element within the filter housing. The radial seal can have, in particular, a compensation groove. For this purpose, the compensation groove can be integrated in the raw-gas-side surface of the radial seal.

It has been found advantageous for the seal of the filter element to consist of an elastomer, in particular, a polyurethane (PU) of a soft foam, a thermoplastic elastomer (TPE) or an ethylene propylene diene rubber (EPDM). Elastomers having Shore hardnesses of 15-50 Shore A are preferred.

The seal can be manufactured in a separate manufacturing process and coupled to the filter frame in an interlocking manner. For interlocking connection, in particular, a circumferential groove can be provided in the seal which engages a circumferential tongue, in particular, on the filter frame. The tongue can be formed, as the case may be, by the L section. This enables a kind of inside-out fitting of the seal over the filter frame during assembly of the filter element and, in an ecologically advantageous manner, reuse of the seal for a new filter frame and bellows unit.

Alternatively, the seal can be produced in one manufacturing step and adhesively bonded to the filter frame. To do this, the seal can be foamed or molded onto the filter frame in a manner advantageous from a production engineering point of view.

The bellows could have a plurality of layers, including one of activated carbon. By these means, the filter element can be used as a combined filter able to absorb noxious smells or gases as well as dust particles.

A filter element of the type described here could be installed in a housing of an air conditioning system.

The invention also relates to a filter assembly, comprising a filter element as described above, and comprising a filter housing for the releasable accommodation and support of the filter element. According to the invention, at least one housing-side mechanical encoding element is integrated in the filter housing. The mechanical encoding element has a specific geometry and is formed to be spatial and physical. The filter-side encoding element and the housing-side encoding element have a complementary design and thus form together an encoding device. If a plurality of housing-side encoding elements are provided, the same number of filter-side encoding elements can be provided.

In a particularly advantageous and thus preferred further development of the filter assembly according to the invention, the housing-side encoding element is configured to be an elevation, in particular a tongue, nose or rib, which is elevated from the internal surface of the filter housing. The internal surface of the filter housing faces the externally circumferential seal of the filter element, when the latter is installed in the filter housing.

Such an elevation is easily produced in production engineering. If the filter-side encoding element is configured to be a recess, the housing-side elevation can be received in the recess provided in the seal.

In a possible embodiment of the filter assembly, the elevation only extends over part of the height of the filter housing. This ensures particularly good sealing of the seal with the filter housing. In this context, the height of the filter housing refers to the extension of the filter housing in the insertion direction.

In a filter assembly which is particularly advantageous and suitable from a production engineering point of view, the elevation is integral and of the same material as the filter housing and, e. g., produced of a plastic material by an injection-molding process.

It has been found to be advantageous for the filter housing of the filter assembly to have a step as a circumferential shoulder, which forms a contact surface for the seal, namely an axial contact surface. This ensures particularly secure mounting of the filter element inside the filter housing.

In an advantageous embodiment of the filter assembly, the bellows is in a filter plane, and the insertion direction during installation of the filter element in the filter housing is oriented perpendicular to the filter plane. Such a filter assembly is also referred to as a top loader (in contrast to so-called front loaders). With such a filter assembly, it has been found advantageous for the encoding elements to extend in the insertion direction and thus perpendicular to the filter plane. In a possible embodiment, an elevation and a recess can extend in the insertion direction as encoding elements and engage each other during installation.

The invention also relates to the use of a filter assembly as described above as an interior air filter for filtering and cleaning the cabin air in an automotive vehicle, which is exposed to increased emission contamination, in particular in an industrial vehicle, a heavy-goods vehicle or an offroad vehicle. These vehicles can be, for example, haulage trucks, building machines, agricultural machines or forestry vehicles.

The use of the filter element in the passenger cabin of a vehicle can be used for the filtration of secondary air or fresh air. In the present context, secondary air is air which is first withdrawn from the passenger cabin and then recirculated into it in a filtered state.

The described invention and the described advantageous embodiments of the invention, also when combined with each other—insofar as this makes sense from an engineering point of view—are advantageous embodiments of the invention.

Further advantages and advantageous embodiments from a structural and functional point of view can be derived from the description of exemplary embodiments with reference to the accompanying drawings.

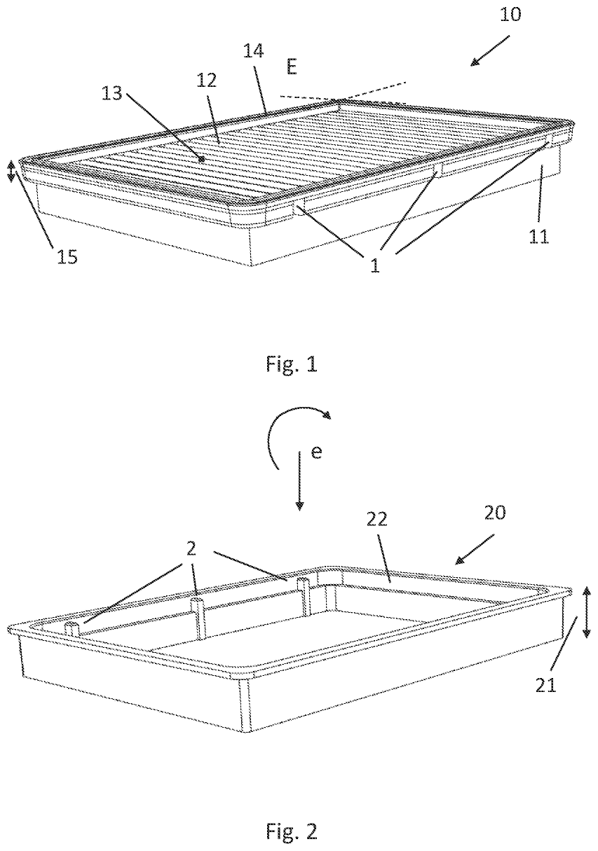

FIG. 1 shows a filter element 10 in a perspective view. The filter element 10 has a filter frame 11 and a bellows 12 of a pleated filter medium 13 accommodated in the filter frame 11. The bellows 12 is situated in a filter plane E. On the outside of the filter frame 11, a circumferential seal 14 is mounted, which is formed as a radial seal.

Three filter-side mechanical encoding elements 1 are integrated in the seal 14, which are configured to be recesses, each in the shape of a notch.

The seal 14—as indicated with a double arrow 15—has a regular height. In the region of the three filter-side encoding elements 1, however, its height is reduced.

FIG. 2 shows a filter housing 20 for the filter element 10 shown in FIG. 1 in a perspective view.

Three housing-side mechanical encoding elements 2 are integrated in the filter housing 20. The housing-side encoding elements 2 are each configured to be elevations, namely noses. The filter-side encoding elements 1 and the housing-side encoding elements 2 are thus configured to be complementary to each other, can engage each other during installation, and together form an encoding device.

The noses 2 are integral and of the same material as the filter housing 20 and are made, for example, of a plastic material in an injection-molding method. The noses 2 only extend over a part of the height 21 of the filter housing 20, which is indicated by a double arrow. The filter housing 20, on its inner side, has a step as a circumferential shoulder 22. This step forms an axial contact surface for the seal 14.

If the filter element 10 shown in FIG. 1 is rotated in the filter plane E by 180°— as indicated by the curved arrow—it can be inserted into the filter housing 20 of FIG. 2 in the insertion direction e—as also indicated by an arrow—and thus installed. The noses 2 engage the notches 1, and the seal 14 comes into contact with the step 22. The filter element 10 thus comes to sit in the filter housing 20 in an unequivocally defined position. Other filter elements 10 without the filter-side encoding elements 1, however, cannot be installed in the filter housing 20 in a securely sealing manner.

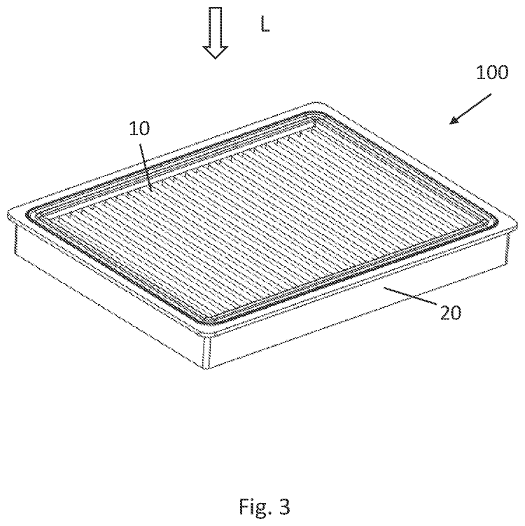

FIG. 3 shows a filter assembly 100, comprising the filter element 10 installed in the filter housing 20 in this manner. An air flow to be cleaned can only flow through the filter assembly 100 in the flow-through direction L.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 filter-side encoding element (recess)
2 housing-side encoding element (elevation)
10 filter element
11 filter frame
12 bellows
13 filter medium
14 seal
15 height of seal
20 filter housing
21 height of filter housing
22 shoulder
100 filter assembly
e insertion direction
E filter plane
L flow-through direction of air flow

1. A filter element, comprising:
a filter frame;
a bellows of a filter medium accommodated in the filter frame; and
a seal externally circumferential on the filter frame,
wherein at least one filter-side mechanical encoding element in integrated in the seal,
wherein the at least one filter-side encoding element is configured to be a recess in the seal, the recess comprising a groove, a notch, or a trough,
wherein the seal has a reduced height in a region of the filter-side encoding element, and
wherein the seal comprises a radial seal.

2. The filter element of claim 1, wherein the radial seal has a compensation groove.

3. The filter element of claim 1, wherein the seal is coupled to the filter frame in an interlocking manner, and
wherein, to create the interlocking connection, a groove is disposable in the seal and a tongue is providable on the filter frame, the groove and the tongue engaging each other.

4. The filter element of claim 1, wherein the seal is foamed, or molded, onto the filter frame so as to provide an adhesive bond between the seal and the filter frame.

5. A filter assembly, comprising:
the filter element of claim 1; and
a filter housing configured to accommodate the filter element,
wherein at least one housing-side mechanical encoding element is integrated in the filter housing, and
wherein the at least one filter-side encoding element and the at least one housing-side encoding element together form an encoding device.

6. The filter assembly of claim 5, wherein the at least one housing-side encoding element comprises an elevation comprising tongue, nose, or rib.

7. The filter assembly of claim 6, wherein the elevation only extends over part of a height of the filter housing.

8. The filter assembly of claim 6, wherein the elevation is integral and a same material as the filter housing.

9. The filter assembly of claim 5, wherein the filter housing, on an inner side thereof, has a step as a circumferential shoulder.

10. The filter assembly according claim 5, wherein the bellows is in a filter plane,
wherein an insertion direction of the filter element into the filter housing is oriented perpendicular to the filter plane, and
wherein the encoding elements extend in the insertion direction.

11. A method, comprising:
using the filter element of claim 1 in a passenger cabin of a vehicle to filter secondary air or fresh air.

12. A method, comprising:
using the filter assembly of claim 5 in a passenger cabin of a vehicle to secondary air or fresh air.
